(19) United States
(12) Patent Application Publication
(10) Pub. No.: US 2020/0346365 A1
(43) Pub. Date: Nov. 5, 2020

(54) CEMENTED CARBIDE POWDERS FOR ADDITIVE MANUFACTURING

(71) Applicant: Kennametal Inc., Latrobe, PA (US)

(72) Inventors: Zhuqing WANG, Latrobe, PA (US); Paul D. PRICHARD, Greensburg, PA (US)

(21) Appl. No.: 16/402,530

(22) Filed: May 3, 2019

(51) Int. Cl. B28B 1/00; B28B 17/02; C04B 35/56; C04B 35/626; C04B 35/63

(52) U.S. Cl. CPC B28B 1/001; B28B 1/004; B28B 17/026; C04B 35/5626; C04B 35/6261; C04B 2235/77; C04B 35/6303; C04B 2235/3847; C04B 2235/5472; C04B 2235/66; C04B 35/62665

(57) ABSTRACT

Cemented carbide powder compositions are provided for use in the production of various articles by one or more additive manufacturing techniques. In one aspect, a powder composition comprises sintered cemented carbide particles having at least a bimodal particle size distribution, wherein sintered cemented carbide particles of a first mode exhibit a D50 particle size of 25 μm to 50 μm, and sintered cemented carbide particles of a second mode exhibit a D50 of less than 10 μm, and the powder composition has an apparent density of 3.5 g/cm³ to 8 g/cm³.

### FIELD

The present invention relates to cemented carbide powders and, in particular, to cemented carbide powders for use with one or more additive manufacturing techniques.

### BACKGROUND

Additive manufacturing generally encompasses processes in which digital 3-dimensional (3D) design data is employed to fabricate an article or component in layers by material deposition and processing. Various techniques have been developed falling under the umbrella of additive manufacturing. Additive manufacturing offers an efficient and cost-effective alternative to traditional article fabrication techniques based on molding processes. With additive manufacturing, the significant time and expense of mold and/or die construction and other tooling can be obviated. Further, additive manufacturing techniques make an efficient use of materials by permitting recycling in the process and precluding the requirement of mold lubricants and coolant. Most importantly, additive manufacturing enables significant freedom in article design. Articles having highly complex shapes can be produced without significant expense allowing the development and evaluation of a series of article designs prior to final design selection.

### SUMMARY

Cemented carbide powder compositions are provided for use in the production of various articles by one or more additive manufacturing techniques. In one aspect, a powder composition comprises sintered cemented carbide particles having at least a bimodal particle size distribution, wherein sintered cemented carbide particles of a first mode exhibit a D50 particle size of 25 μm to 50 μm, and sintered cemented carbide particles of a second mode exhibit a D50 of less than 10 μm, and the powder composition has an apparent density of 3.5 g/cm³ to 8 g/cm³.

In another aspect, a powder composition for additive manufacturing techniques comprises sintered cemented carbide particles having at least a bimodal particle size distribution, wherein sintered cemented carbide particles of a first mode exhibit a D50 particle size of 25 μm to 50 μm, and sintered cemented carbide particles of a second mode exhibit a D50 of less than 10 μm, and the sintered cemented carbide particles of the first and second modes have an average individual particle porosity of less than 5 vol. %.

In another aspect, green articles having advantageous mechanical and/or strength properties are described herein. A green article, in some embodiments, comprises particles of a powder composition bound together by a binder phase applied in an additive manufacturing technique, wherein the green article has an average transverse rupture strength of at least 2 MPa, and the powder composition comprises sintered cemented carbide particles having at least a bimodal particle size distribution, wherein sintered cemented carbide particles of a first mode exhibit a D50 particle size of 25 μm to 50 μm, and sintered cemented carbide particles of a second mode exhibit a D50 of less than 10 μm, and the powder composition has an apparent density of 3.5 g/cm³ to 8 g/cm³ in absence of the binder phase.

In another aspect, a green article comprises particles of a powder composition bound together by a binder phase applied in an additive manufacturing technique, wherein the green article has an average transverse rupture strength of at least 2 MPa, and the powder composition comprises sintered cemented carbide particles having at least a bimodal particle size distribution, wherein sintered cemented carbide particles of a first mode exhibit a D50 particle size of 25 μm to 50 μm, and sintered cemented carbide particles of a second mode exhibit a D50 of less than 10 μm, and the sintered cemented carbide particles of the first and second modes have an average individual particle porosity of less than 5 vol. %.

In further aspects, methods of forming sintered articles are described herein. In some embodiments, a method of forming a sintered article comprises providing a powder composition comprising sintered cemented carbide particles having at least a bimodal particle size distribution, wherein sintered cemented carbide particles of a first mode exhibit a D50 particle size of 25 μm to 50 μm, and sintered cemented carbide particles of a second mode exhibit a D50 of less than 10 μm, and the powder composition has an apparent density of 3.5 g/cm³ to 8 g/cm³, and forming the powder composition into a green article by one or more additive manufacturing techniques. The green article is then sintered to provide the sintered article.

In other embodiments, a method of making a sintered article comprises providing a powder composition comprising sintered cemented carbide particles having at least a bimodal particle size distribution, wherein sintered cemented carbide particles of a first mode exhibit a D50 particle size of 25 μm to 50 μm, and sintered cemented carbide particles of a second mode exhibit a D50 of less than 10 μm, and the sintered cemented carbide particles of the first and second modes have an average individual particle porosity of less than 5 vol. %, and forming the powder composition into a green article by one or more additive manufacturing techniques. The green article is then sintered to provide the sintered article. Additive manufacturing techniques employed for green article formation can include binder jetting, in some embodiments.

These and other embodiments are further described in the following detailed description.

### BRIEF DESCRIPTION OF THE DRAWINGS

FIGS. 1-4 are cross-sectional scanning electron microscopy (SEM) images of sintered cemented carbide particles of bimodal powder compositions according to some embodiments.

FIGS. 5-8 are cross-sectional optical images of sintered articles produced with bimodal powder compositions described herein, according to some embodiments.

FIGS. 9 and 10 are cross-sectional optical images of sintered articles produced with comparative powder compositions.

FIG. 11 provides transverse rupture strengths (TRS) along X/Y directions and the Z direction for green bars printed with bimodal powder compositions described herein according to some embodiments.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### I. Powder Compositions

In one aspect, powder compositions are provided for article manufacture by various additive manufacturing techniques. In some embodiments, a powder composition comprises sintered cemented carbide particles having at least a bimodal particle size distribution, wherein sintered cemented carbide particles of a first mode exhibit a D50 particle size of 25 μm to 50 μm, and sintered cemented carbide particles of a second mode exhibit a D50 of less than 10 μm, and the powder composition has an apparent density of 3.5 g/cm³ to 8 g/cm³. In some embodiments, the powder composition has an apparent density of 4 g/cm³ to 7 g/cm³ or from 5 g/cm³ to 6 g/cm³. As known to one of skill in the art, apparent density is the mass of a unit volume of powder or particles in the loose condition, usually expressed in g/cm³.

In another aspect, a powder composition for additive manufacturing techniques comprises sintered cemented carbide particles having at least a bimodal particle size distribution, wherein sintered cemented carbide particles of a first mode exhibit a D50 particle size of 25 μm to 50 μm, and sintered cemented carbide particles of a second mode exhibit a D50 of less than 10 μm, and the sintered cemented carbide particles of the first and second modes have an average individual particle porosity of less than 5 vol. %.

Turning now to specific components, powder compositions described herein comprise sintered cemented carbide particles having at least a bimodal particle size distribution. The bimodal distribution comprises a first mode exhibiting a D50 particle size of 25 μm to 50 μm and a second mode exhibiting a D50 of less than 10 μm. In some embodiments, the second mode has a D50 in the range of 3 μm to 9 μm. Sintered cemented carbide particles of the first and second modes can be present in the powder composition in any desired amounts. In some embodiments, for example, sintered cemented carbide particles of the first mode are present in the powder composition in an amount of 60 weight percent to 80 weight percent, and sintered cemented carbide particles of the second mode are present in the powder composition in an amount of 20 weight percent to 40 weight percent. Moreover, a ratio of D50 size of the first mode to the D50 size of the second mode can generally have a value of 4 to 10. In some embodiments, the ratio have a value of 6 to 10 or 7 to 10.

Sintered cemented carbide particles of the powder composition each comprise individual metal carbide grains sintered and bound together by a metallic binder phase. In some embodiments, sintered cemented carbide particles of the first and second modes have an average individual particle porosity of less than 5 vol. %. Moreover, sintered cemented carbide particles of the second mode can have an average individual particle porosity less than 2%, in some embodiments.

As described further herein, the foregoing apparent densities and individual particle porosities of the first and second modes can be achieved through one or several sintering processes administered to the particles. The sintering processes, in some embodiments, do not employ sintering inhibitor(s) to mitigate particle sticking or adhesion. Sintered cemented carbide particle properties described herein can be achieved in the absence of sintering inhibitor(s). In some embodiments, sintered cemented carbide particles are prepared by sintering a grade powder composition at temperatures of 1100° C. to 1400° C. for 0.5 to 2 hours to provide a sintered compact. The sintered compact is subsequently milled to provide individual sintered cemented carbide particles. Depending on particle morphology and density, the sintered cemented carbide particles can be further heat treated for further densification. Further heat treatment can include plasma densification, such as plasma spheroidization using an RF plasma torch or DC plasma torch. Alternatively, the sintered cemented carbide particles can be re-sintered forming a second compact. The second compact is milled to provide the sintered cemented carbide particles. Further densification treatments can be administered any desired number of times to provide sintered cemented carbide particles desired apparent densities, tap densities and/or individual particle densities. Sintering times and temperatures can be selected according to several considerations including, but not limited to, binder content of the cemented carbide particles, desired sintered particle density and sintering stage. In some embodiments, early sintering stages are conducted at lower temperatures and/or shorter times to facilitate milling the sintered compact. For example, an initial or early stage sintering process may be administered at temperatures below binder liquefaction. Late stage or final sintering processes may achieve higher temperatures, such as temperatures at which liquid phase sintering takes place.

In some embodiments, for example, particles of the first mode having a D50 of 25 μm to 50 μm are produced by milling tungsten carbide powder with powder metallic binder. After milling, the tungsten carbide particles are coated with metallic binder and subsequently spray dried and sintered under vacuum according to the conditions above. The sintered powder is milled to reach the desired particle size distribution. In some embodiments, the powder may be resintered and milled to achieve higher individual particle densities and lower individual particle porosities. Alternatively, the powder may be further densified by additional heat treatment, including plasma densification. In some embodiments, sintered cemented carbide particles of the first mode have are spherical.

Moreover, particles of the second mode having a D50 of less than 10 μm can be produced by ball milling sintered cemented carbide particles of the first mode. Such milling further reduces particle size and can induce a non-spherical or irregular-shaped particle morphology.

Sintered cemented carbide particles of the first and second modes comprise one or more metal carbides selected from the group consisting of Group IVB metal carbides, Group VB metal carbides and Group VIB metal carbides. In some embodiments, tungsten carbide is the sole metal carbide of the sintered particles. In other embodiments, one or more Group IVB, Group VB and/or Group VIB metal carbides are combined with tungsten carbide to provide the sintered particles. For example, chromium carbide, titanium carbide, vanadium carbide, tantalum carbide, niobium carbide, zirconium carbide and/or hafnium carbide and/or solid solutions thereof can be combined with tungsten carbide in sintered particle production. Tungsten carbide can generally be present in the sintered particles in an amount of at least about 80 or 85 weight percent. In some embodiments, Group IVB, VB and/or VIB metal carbides other than tungsten carbide are present in the sintered particles in an amount of 0.1 to 5 weight percent.

In some embodiments, the sintered cemented carbide particles do not comprise double metal carbides or lower metal carbides. Double and/or lower metal carbides include, but are not limited to, eta phase (Co₃W₃C or Co₆W₆C), W₂C and/or W₃C. Moreover, sintered articles fonned from sintered cemented carbide particles, in some embodiments, also do not comprise non-stoichiometric metal carbides. Additionally, the sintered cemented carbide particles can exhibit uniform or substantially uniform microstructure.

Sintered cemented carbide particles of the first and second modes comprise metallic binder. Metallic binder of sintered cemented carbide particles can be selected from the group consisting of cobalt, nickel and iron and alloys thereof. In some embodiments, metallic binder is present in the sintered cemented carbide particles in an amount of 0.1 to 15 weight percent. Metallic binder can also be present in the sintered cemented carbide particles in an amount selected from Table IV.

TABLE IV
Metallic Binder Content (wt. %)
1-13
2-10
5-12

Metallic binder of the sintered cemented carbide particles can also comprise one or more additives, such as noble metal additives. In some embodiments, the metallic binder can comprise an additive selected from the group consisting of platinum, palladium, rhenium, rhodium and ruthenium and alloys thereof. In other embodiments, an additive to the metallic binder can comprise molybdenum, silicon or combinations thereof. Additive can be present in the metallic binder in any amount not inconsistent with the objectives of the present invention. For example, additive(s) can be present in the metallic binder in an amount of 0.1 to 10 weight percent of the sintered cemented carbide particles.

Compositions of the sintered cemented carbide particles of the first and second modes can be substantially the same or can differ. For example, sintered cemented carbide particles of the first mode can differ from sintered cemented carbide particles of the second mode in composition and/or size of individual metal carbide grains as wells as composition and/or weight percent of metallic binder. Additionally, in some embodiments, the first mode of sintered cemented carbide particles is the major mode, and the second mode of sintered cemented carbide particles is the minor mode. In such embodiments, the second mode may exhibit very low polydipsersity in a particle size range of 3 μm to 9 μm.

### II. Green Articles

As described herein, the sintered cemented carbide particles are formed into a green article by one or more additive manufacturing techniques. A green article, in some embodiments, comprises particles of a powder composition bound together by a binder phase applied in an additive manufacturing technique, wherein the green article has an average transverse rupture strength of at least 2 MPa, and the powder composition comprises sintered cemented carbide particles having at least a bimodal particle size distribution, wherein sintered cemented carbide particles of a first mode exhibit a D50 particle size of 25 μm to 50 μm, and sintered cemented carbide particles of a second mode exhibit a D50 of less than 10 μm, and the powder composition has an apparent density of 3.5 g/cm³ to 8 g/cm³ in absence of the binder phase.

In another aspect, a green article comprises particles of a powder composition bound together by a binder phase applied in an additive manufacturing technique, wherein the green article has an average transverse rupture strength of at least 2 MPa, and the powder composition comprises sintered cemented carbide particles having at least a bimodal particle size distribution, wherein sintered cemented carbide particles of a first mode exhibit a D50 particle size of 25 μm to 50 μm, and sintered cemented carbide particles of a second mode exhibit a D50 of less than 10 μm, and the sintered cemented carbide particles of the first and second modes have an average individual particle porosity of less than 5 vol. %.

Powders forming the green articles via one more additive manufacturing techniques can have any composition and/or properties described in Section I above. Additionally, any additive manufacturing technique operable to form the sintered cemented carbide powder into a green article can be employed. In some embodiments, additive manufacturing techniques employing a powder bed are used to construct green articles formed of sintered cemented carbide powder. For example, binder jetting can provide a green article formed of sintered cemented carbide powder. In the binder jetting process, an electronic file detailing the design parameters of the green part is provided. The binder jetting apparatus spreads a layer of sintered cemented carbide powder in a build box. A printhead moves over the powder layer depositing liquid binder according to design parameters for that layer. The layer is dried, and the build box is lowered. A new layer of sintered cemented carbide powder is spread, and the process is repeated until the green article is completed. In some embodiments, other 3D printing apparatus can be used to construct the green article from the sintered cemented carbide powder in conjunction with organic binder.

Any organic binder not inconsistent with the objectives of the present invention can be employed in formation of the green article by one or more additive manufacturing techniques. In some embodiments, organic binder comprises one or more polymeric materials, such as polyvinylpyrrolidone (PVP), polyethylene glycol (PEG) or mixtures thereof. Organic binder, in some embodiments, is curable which can enhance strength of the green article. The polymer binder used in printing can be aqueous binder or solvent binder. Additionally, the green articles can exhibit binder saturation of at least 80%, in some embodiments. Binder saturation, for example, can be set to 100% or greater than 100%, in some embodiments.

Green articles described herein can exhibit advantageous mechanical and/or strength properties. In some embodiments, a green article exhibits an average transverse rupture strength (TRS) in the X/Y directions and Z direction of at least 2 MPa. Additionally, a green article can have an average transverse rupture strength in the X/Y directions according to Table II.

TABLE II
TRS of Green Article (X/Y Directions - MPa)
≥3
≥4
≥5
3-6

Transverse rupture strength values for green articles described herein are determined according to ASTM B312-14: Standard Test Method for Green Strength of Specimens Compacted from Metal Powders, ASM International, West Conshohocken, Pa., 2014, pp. 1-6.

Green articles formed from powder compositions described herein can be sintered under conditions and for time periods to provide sintered articles having the desired density. The green article can be vacuum sintered or sintered under a hydrogen or argon atmosphere at temperatures of 1300° C. to 1560° C. Moreover, sintering times can generally range from 10 minutes to 5 hours. In some embodiments, hot isostatic pressing (HIP) is added to the sintering process. Hot isostatic pressing can be administered as a post-sinter operation or during vacuum sintering. Hot isostatic pressing can be administered for up to 2 hours at pressures of 1 MPa to 300 MPa and temperatures of 1300° C. to 1560° C. Sintered articles described herein can exhibit densities greater than 98% theoretical full density. Density of a sintered article can be at least 99% theoretical full density. In some embodiments, sintered articles have a porosity of A00B00C00. Moreover, microstructure of the sintered articles can be uniform, in some embodiments. Non-stoichiometric metal carbides, such as eta phase, W₂C and/or W₃C, may also be absent in the sintered articles. Alternatively, sintered cemented carbide articles can comprise non-stoichiometric metal carbide(s) in minor amounts (generally <5 wt. % or <1 wt. %). Moreover, a sintered article described herein can have an average grain size of 1-50 vim or 10-40 μm, in some embodiments.

In some embodiments, a sintered article produced according to methods described herein exhibits less than 25 vol. % shrinkage or less than 20 vol. % shrinkage in one or more dimensions relative to the green article. Linear shrinkage of the sintered article in one more dimensions relative to the green article can also have a value selected from Table III.

TABLE III
Linear Shrinkage of Sintered Article (Vol. %)

≤15
≤10
≤5
5-25
5-10
1-10
1-5

Sintered articles produced according to methods described herein can be employed in a variety of industries including petrochemical, automotive, aerospace, industrial tooling, metal cutting tools and manufacturing. In some embodiments, the sintered articles are used as components exposed to wear environments or abrasive operating conditions such as flow control components, pumps, bearings, valves, valve components, centrifuge components, disk stacks and/or fluid handling components. The sintered article can also comprise one or more internal fluid flow channels formed by the additive manufacturing technique. In some embodiments, sintered articles are near-net shape and/or require minimal post sintering processing to place the articles in final form. These and other embodiments are further illustrated by the following non-limiting examples.

### Examples

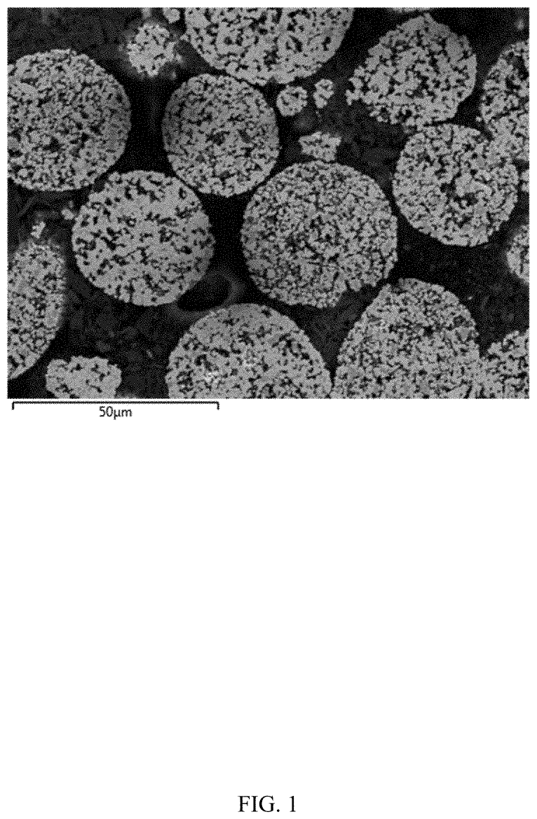

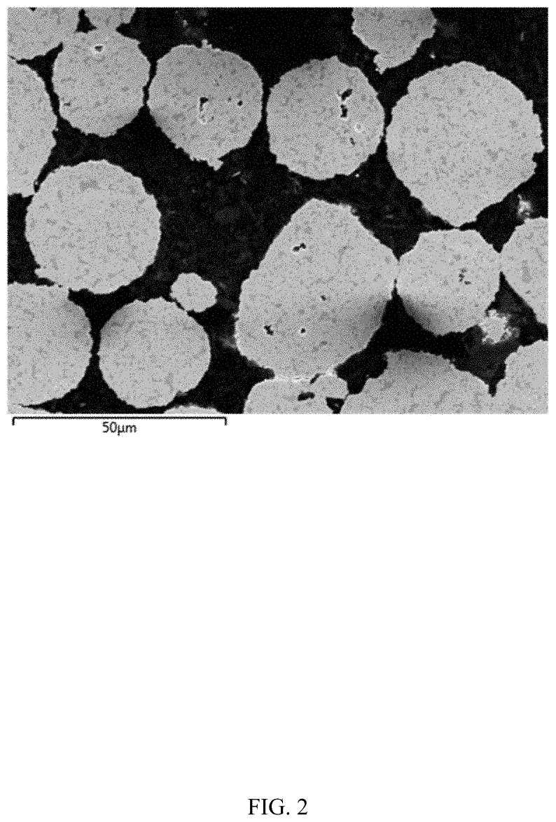

Spherical porous coarse powder, GU1, was produced by milling 88 wt. % tungsten carbide (WC) particle with 12 wt. % cobalt powder. After milling, WC-12Co grade was made and the powder was spray dried and sintered in vacuum (<10⁻³ torr) in the solid state at 1150-1200° C. for 1-2 hours, forming a lightly sintered compact. The sintered compact was milled and sieved to reach the desired powder size distribution. Spherical dense powder, GU2, was produced by re-sintering GU1 powder in vacuum (<10⁻³ torr) in a partial liquid state at 1280-1350 C for 1-2 hours, providing a porous sintered compact. The sintered compact was ball milled followed by impact milling to provide the GU2 powder. FIG. 1 is a scanning electron micrograph (SEM) of a cross-sectional view of GU1 powder, and FIG. 2 is an SEM of a cross-sectional view of GU2 powder. As provided in FIGS. 1-2, the GU2 powder exhibited lower porosity and higher density for the individual sintered particles.

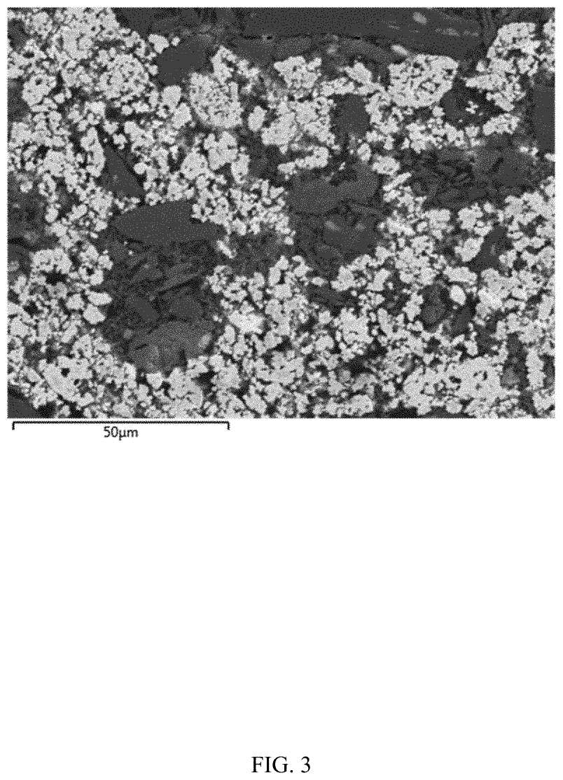

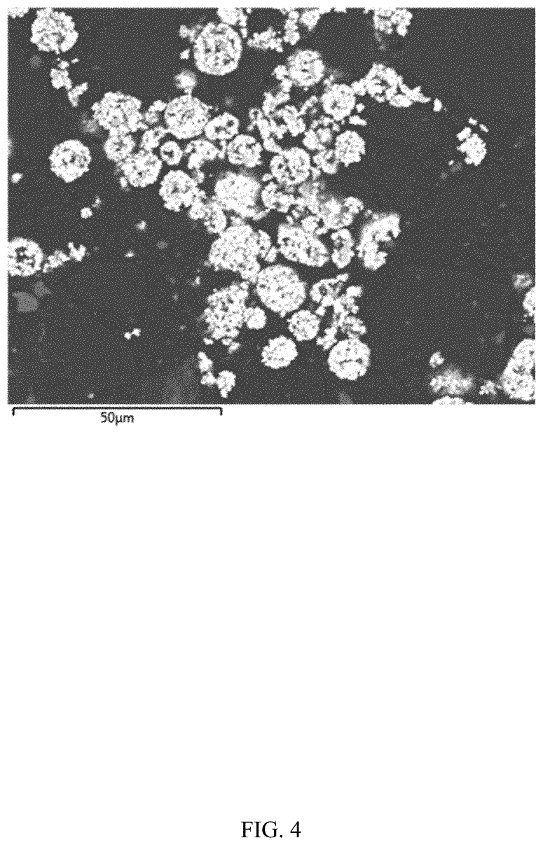

Fine powder was produced by ball milling GU1 powder for 8 hours. Two batches of fine powder with slightly different powder size distribution were obtained, named as CT1 and CT2. A cross-sectional SEM of CT1 powder is provided in FIG. 3. Another batch of coarser fine powder, CT3, was produced using the same method as GU2. A cross-sectional SEM of CT3 particles is provided in FIG. 4.

Table IV summarizes the chemistry, powder size distribution (D10, D50, and D90), porosity, and shape of all the coarse (GU1, GU2) and fine (CT1, CT2, CT3) powders. The weight fractions of Co and Cr were measured using X-ray fluorescence (XRF). The powder size distribution was measured using laser scattering method from Micro-trac. In order to quantify the porosity, different batches of powder were mounted and polished to take scanning electron microscopy (SEM) images (FIGS. 1-4). Image processing software, Image J, was applied to the images to compute porosity.

TABLE IV
Powder Properties

| | Co | Cr | D10 | D50 | D90 | Porosity | |
|---|---|---|---|---|---|---|---|
| Powder | (wt. %) | (wt. %) | (μm) | (μm) | (μm) | (%) | Shape |
| GU1 | 12.0 | 0.2 | 29.1 | 37.5 | 49.5 | 19.9 | Spherical |
| | | | | | | | (FIG. 1) |
| GU2 | 12.0 | 0.2 | 8.1 | 32.9 | 50.0 | 0.9 | Spherical |
| | | | | | | | (FIG. 2) |
| CT1 | 12.0 | 0.2 | 1.8 | 7.1 | 14.0 | 0 | Non- |
| | | | | | | | spherical |
| | | | | | | | (FIG. 3) |
| CT2 | 12.1 | 0.2 | 0.9 | 5.0 | 13.5 | 0 | Non- |
| | | | | | | | spherical |
| CT3 | 11.9 | 0.2 | 4.4 | 10.4 | 16.8 | 5.5 | Spherical |
| | | | | | | | (FIG. 4) |

Seven batches of bimodal powder mixtures were made by mixing coarse and fine powder, as shown in Table V.

TABLE V
Bimodal Powder Properties

| | | | Apparent | Tap | Pycnometer | | | |
|---|---|---|---|---|---|---|---|---|
| Batch | | Fine | density | density | density | D10 | D50 | D90 |
| number | Coarse powder | powder | (g/cm³) | (g/cm³) | (g/cm³) | (μm) | (μm) | (μm) |
| 1 | 70% GU1 | 30% CT1 | 4.6 | 6.1 | 13.8 | 10.9 | 35.0 | 48.4 |
| 2 | 70% GU2 | 30% CT2 | 5.8 | 8.4 | 14.0 | 8.9 | 32.5 | 49.4 |
| 3 | 63% GU1 + 7% | 30% CT1 | 4.8 | 6.5 | 14.2 | 11.9 | 32.6 | 48.0 |
| | GU2 | | | | | | | |
| 4 | 35% GU1 + 35% | 30% CT1 | 5.4 | 7.2 | 14.1 | 10.9 | 32.6 | 48.4 |
| | GU2 | | | | | | | |
| 5 | 70% GU2 | 30% CT3 | 5.8 | 8.1 | 14.2 | 10.6 | 31.5 | 48.5 |
| 6 | 50% GU2 | 50% CT3 | 5.0 | 6.9 | 14.1 | 7.2 | 24.6 | 47.0 |
| 7 | 30% GU2 | 70% CT3 | 4.6 | 6.1 | 14.4 | 7.1 | 17.4 | 43.8 |

Cubes and transverse rupture bars were printed from the bimodal powder mixtures using a binder jetting machine ExOne Innovent equipped with an 80 pL print head. The layer thickness was 100 μm. Both aqueous and solvent binders were used with a binder saturation of 80%, as shown in Table VI.

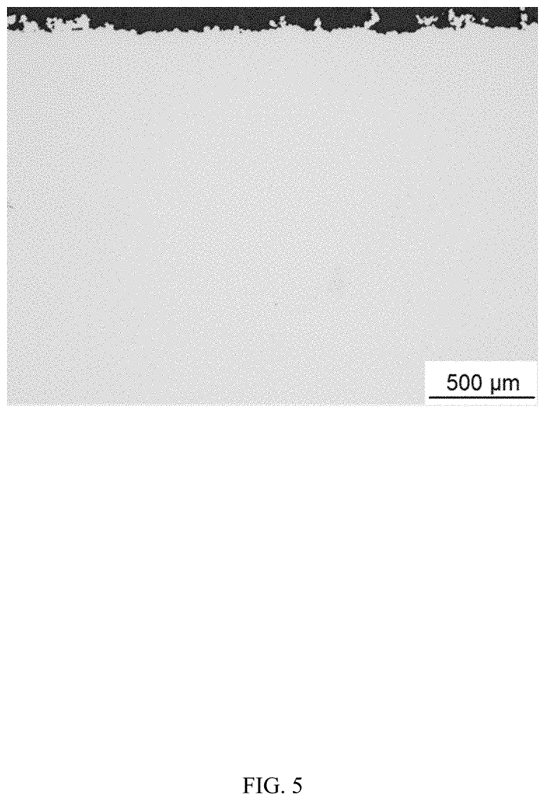

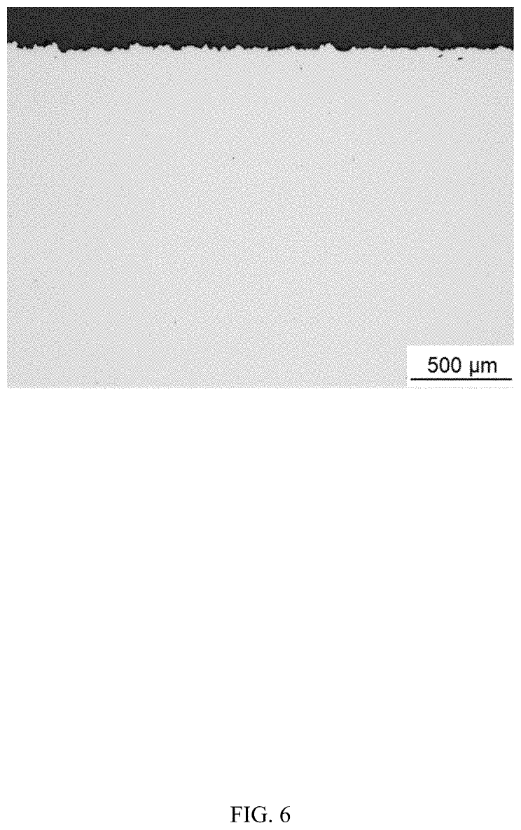

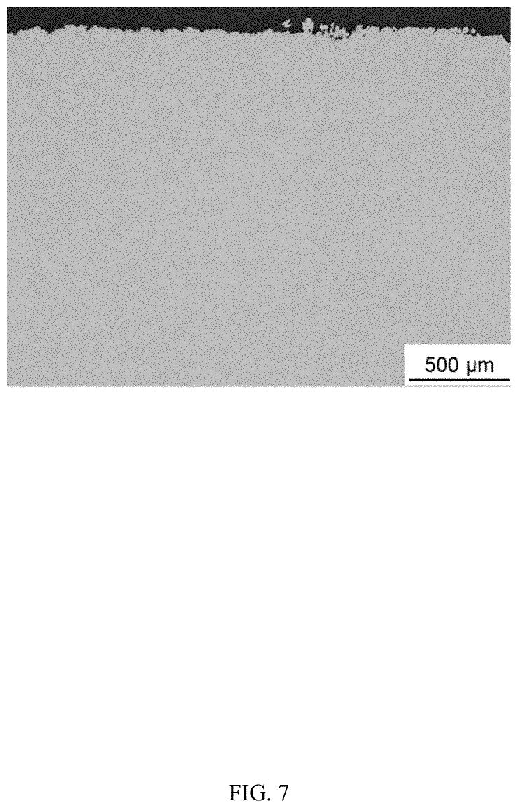

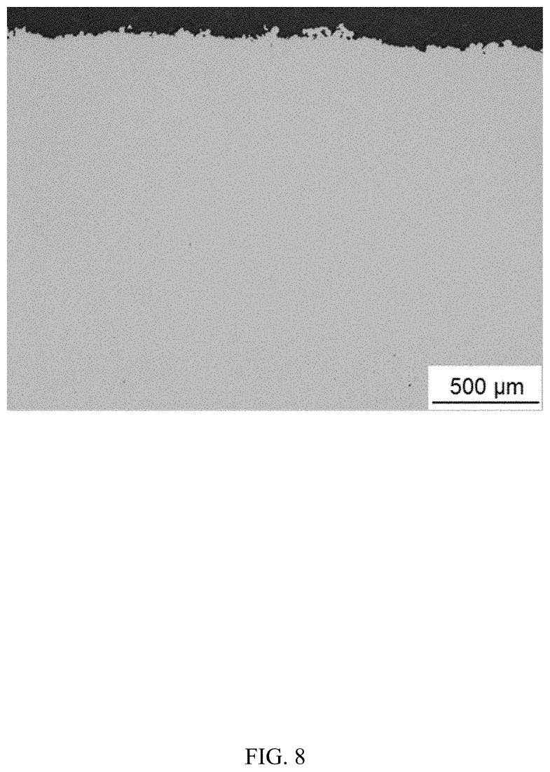

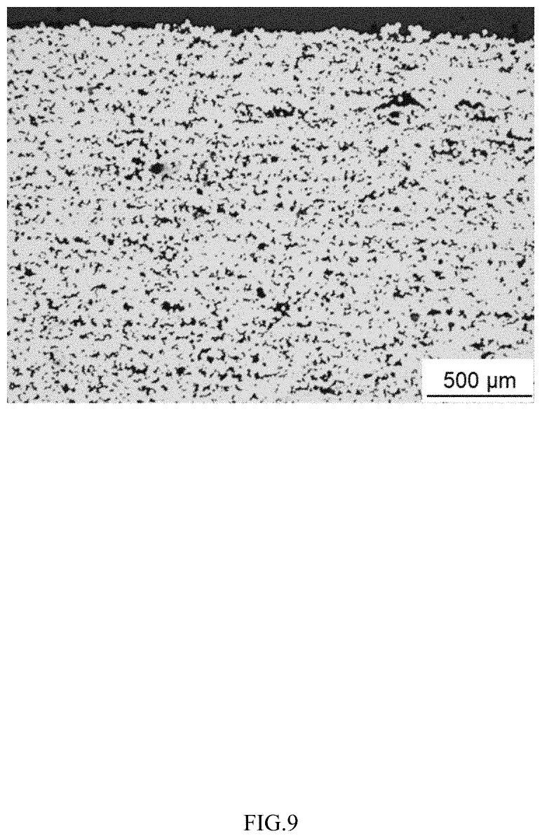

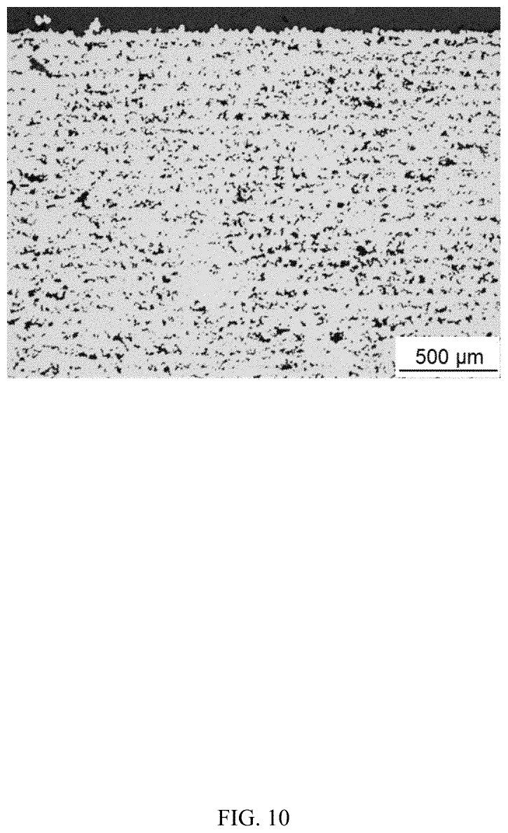

TABLE VI
Properties of WC—12Co Samples Printed Using Bimodal Powder Mixtures

| | | | Green | | Magnetic | | | Green | Green |
|---|---|---|---|---|---|---|---|---|---|
| | | Binder | density | Co | saturation | Coercive | | strength, | strength, |
| | Powder | type | (g/cm³) | (wt. %) | (G cm³/g) | force (Oe) | Porosity | X/Y (MPa) | Z (MPa) |
| Sample 1 | Batch 1 | Aqueous | 5.2 | 12.0 | 17.4 | 166 | A00B00C00, | 0.3 | 0.05 |
| | | | | | | | FIG. 5 | | |
| Sample 2 | Batch 1 | Solvent | 5.3 | 12.0 | 17.2 | 167 | A00/A02B00 | NM* | NM |
| Sample 3 | Batch 2 | Aqueous | 7.6 | 11.9 | 17.4 | 166 | A00B00C00, | 3.0 | 1.2 |
| | | | | | | | FIG. 6 | | |
| Sample 4 | Batch 2 | Solvent | 7.6 | 11.9 | 17.5 | 166 | A00B00C00 | NM | NM |
| Sample 5 | Batch 3 | Aqueous | NM | 12.0 | 17.6 | 163 | A00B00C00, | 0.6 | 0.2 |
| | | | | | | | FIG. 7 | | |
| Sample 6 | Batch 4 | Aqueous | 6.0 | 12.0 | 17.6 | 163 | A00/A02C00, | 0.5 | 0.1 |
| | | | | | | | FIG. 8 | | |
| Sample 7 | Batch 5 | Aqueous | 6.5 | 11.9 | 17.4 | 165 | About 10% | 0.4 | 0.06 |
| | | | | | | | porosity, | | |
| | | | | | | | FIG. 9 | | |
| Sample 8 | Batch 6 | Aqueous | 5.8 | 11.8 | 17.5 | 172 | About 6% | NM | NM |
| | | | | | | | porosity, | | |
| | | | | | | | FIG. 10 | | |
| Sample 9 | Batch 7 | Aqueous | 5.7 | 11.8 | 17.7 | 173 | About 1% | NM | NM |
| | | | | | | | porosity | | |

*NM—not measured

The packing density setting on the ExOne Innovent of powder was fixed at 53% for all the powder batches. The transverse rupture bars, measuring 8 mm×8 mm×38 mm, were used to measure green strengths by three-point bend tests, adhering to ASTM B312 standard. Due to the inherently anisotropic properties in as-printed parts, samples in the plane perpendicular to the build direction (X/Y directions) and samples along the build direction (Z direction) were printed. A minimum of 5 bars were tested for each direction and the average value is given in Table VI.

Cubes and transverse rupture bars were cured at 195° C. for 8 h in an air oven. Depowdering was performed by vacuuming the surrounding unprinted powder and gently blowing air on the samples to remove lightly bonded powder from the component surface. Then cubes were transferred to graphite trays coated with a graphite-based parting agent for debinding and sintering. Debinding was performed in a furnace at a temperature up to 650° C. for 1-6 hours with a H₂ flow of 510 l/h. The debound samples were sintered using a sinter-HIP vacuum furnace at a temperature of 1440-1480° C. and a pressure of 4-5.5 MPa in Ar for 45 minutes. The sintered samples were taken from the furnace after they were cooled to room temperature. A shrinkage of 20 to 43 vol. % were observed in the sintered samples compared to as-printed samples. The properties of as-printed and sintered samples are shown in Table VI. The representative microstructures of samples sintered at 1440° C. with 5.5 MPa pressure are shown in FIGS. 5-10. As illustrated in FIGS. 5-8 corresponding to samples 1, 3, 5 and 6 respectively employing inventive powder compositions described herein, the sintered sample showed little to no porosity. This was in sharp contrast to FIGS. 9 and 10 corresponding to comparative powder compositions of samples 7 and 8 where the sintered articles showed substantial porosity (black areas).

As shown in Table VI, samples 1-6 from the bimodal powder mixtures have full density using both aqueous and solvent binders. Samples 7-9 from the bimodal powder mixtures have low density, as the fine powder, CT3, has D50 larger than the defined range (3 μm to 9 μm) or the ratio of the weight fraction of coarse powder to fine powder is not in the defined range for the bimodal powder mixture, as detailed hereinabove.

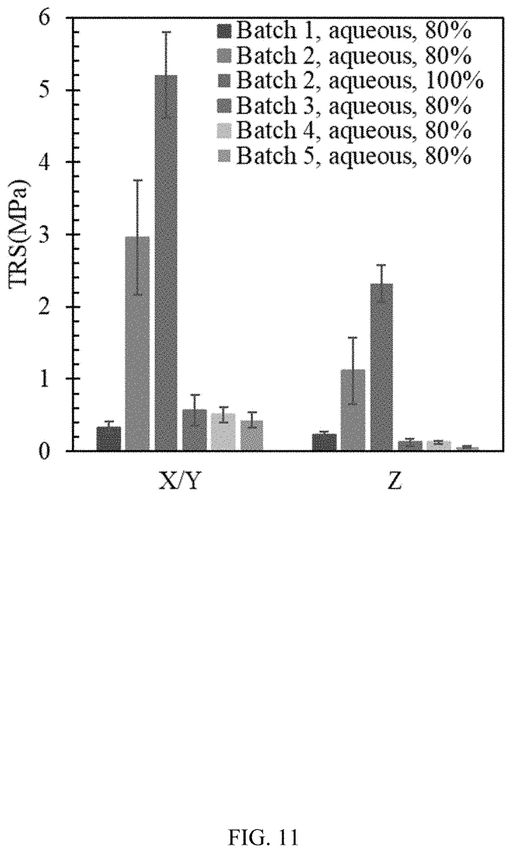

For samples with full density, sample 2 from powder batch 2 has green strength 5-10 times higher than the rest samples in all directions, indicating the corresponding bimodal mixture is ideal to make WC-12Co components. The green strength can be further improved by increasing the binder saturation. When a binder saturation of 100% was used, the average green strength of samples from powder batch 2 was 5.2 MPa along X/Y directions and 2.3 MPa along Z direction. FIG. 11 shows a comparison of green strengths from different powder batches.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A powder composition comprising:
sintered cemented carbide particles having at least a bimodal particle size distribution, wherein sintered cemented carbide particles of a first mode exhibit a D50 particle size of 25 μm to 50 μm, and sintered cemented carbide particles of a second mode exhibit a D50 of less than 10 μm, and the powder composition has an apparent density of 3.5 g/cm³ to 8 g/cm³.

2. The powder composition of claim 1, wherein the sintered cemented carbide particles of the second mode exhibit a D50 of 3 μm to 9 μm.

3. The powder composition of claim 1, wherein the sintered cemented carbide particles of the first mode have an average individual particle porosity of less than 5 vol. %.

4. The powder composition of claim 1, wherein the sintered cemented carbide particles of the first mode are spherical.

5. The powder composition of claim 4, wherein the sintered cemented carbide particles of the second mode are non-spherical.

6. The powder composition of claim 1, wherein the sintered cemented carbide particles of the first and second modes comprise metallic binder in an amount less than 15 weight percent.

7. The powder composition of claim 6, wherein the sintered cemented carbide particles of the first and second modes comprise different amounts of metallic binder.

8. The powder composition of claim 3, wherein the sintered cemented carbide particles of the second mode have an average individual particle porosity less than 2 vol. %.

9. The powder composition of claim 1, wherein the sintered cemented carbide particles of the first mode are present in the powder composition in an amount of 60 weight percent to 80 weight percent, and the sintered cemented carbide particles of the second mode are present in the powder composition in an amount of 20 weight percent to 40 weight percent.

10. The powder composition of claim 1, wherein a ratio of D50 particle size of the first mode to D50 particle size of the second mode has a value of 4 to 10.

11. A powder composition comprising:
sintered cemented carbide particles having at least a bimodal particle size distribution, wherein sintered cemented carbide particles of a first mode exhibit a D50 particle size of 25 μm to 50 μm, and sintered cemented carbide particles of a second mode exhibit a D50 of less than 10 μm, and the sintered cemented carbide particles of the first and second modes have an average individual particle porosity of less than 5 vol. %.

12. The powder composition of claim 11, wherein the sintered cemented carbide particles of the second mode have an average individual particle porosity less than 2 vol. %.

13. The powder composition of claim 1, wherein the sintered cemented carbide particles of the first mode are spherical, and the sintered cemented carbide particles of the second mode are non-spherical.

14. The powder composition of claim 11, wherein the sintered cemented carbide particles of the first mode are present in the powder composition in an amount of 60 weight percent to 80 weight percent, and the sintered cemented carbide particles of the second mode are present in the powder composition in an amount of 20 weight percent to 40 weight percent.

15. The powder composition of claim 11, wherein the sintered cemented carbide particles of the first and second modes comprise individual metal carbide grains of differing size.

16. A green article comprising:
particles of a powder composition bound together by a binder phase applied in an additive manufacturing technique, wherein the green article has an average transverse rupture strength of at least 2 MPa, and the powder composition comprises sintered cemented carbide particles having at least a bimodal particle size distribution, wherein sintered cemented carbide particles of a first mode exhibit a D50 particle size of 25 μm to 50 μm, and sintered cemented carbide particles of a second mode exhibit a D50 of less than 10 μm, and the powder composition has an apparent density of 3.5 g/cm³ to 8 g/cm³ in absence of the organic binder phase.

17. The green article of claim 16 having an average transverse rupture strength of at least 3 MPa in X/Y directions.

18. The green article of claim 16, wherein the sintered cemented carbide particles of the second mode exhibit a D50 of 3 μm to 9 μm.

19. The green article of claim 16, wherein the sintered cemented carbide particles of the first mode are spherical, and the sintered cemented carbide particles of the second mode are non-spherical.

20. The green article of claim 16, wherein the sintered cemented carbide particles of the first mode have an average individual particle porosity of less than 5 vol. %, and the sintered cemented carbide particles of the second mode have an average individual particle porosity less than 2 vol. %.

21. The green article if claim 16, wherein the sintered cemented carbide particles of the first mode are present in the powder composition in an amount of 60 weight percent to 80 weight percent, and the sintered cemented carbide particles of the second mode are present in the powder composition in an amount of 20 weight percent to 40 weight percent.

22. A green article comprising:
particles of a powder composition bound together by a binder phase applied in an additive manufacturing technique, wherein the green article has an average transverse rupture strength of at least 2 MPa, and the powder composition comprises sintered cemented carbide particles having at least a bimodal particle size distribution, wherein sintered cemented carbide particles of a first mode exhibit a D50 particle size of 25 μm to 50 μm, and sintered cemented carbide particles of a second mode exhibit a D50 of less than 10 μm, and the sintered cemented carbide particles of the first and second modes have an average individual particle porosity of less than 5 vol. %.

23. The green article of claim 22, wherein the sintered cemented carbide particles of the first mode are spherical, and the sintered cemented carbide particles of the second mode are non-spherical.

24. A method of forming a sintered article comprising:
providing a powder composition comprising sintered cemented carbide particles having at least a bimodal particle size distribution, wherein sintered cemented carbide particles of a first mode exhibit a D50 particle size of 25 μm to 50 μm, and sintered cemented carbide particles of a second mode exhibit a D50 of less than 10 μm, and the powder composition has an apparent density of 3.5 g/cm³ to 8 g/cm³;
forming the powder composition into a green article by one or more additive manufacturing techniques; and
sintering the green article to provide the sintered article.

25. The method of claim 24, wherein the sintered article is greater than 98% theoretical density.

26. The method of claim 24, wherein the sintered article has a porosity of A02B00C00.

27. The method of claim 24, wherein the green article has an average transverse rupture strength of at least 2 MPa.

28. The method of claim 24, wherein the sintered cemented carbide particles of the first mode are present in the powder composition in an amount of 60 weight percent to 80 weight percent, and the sintered cemented carbide particles of the second mode are present in the powder composition in an amount of 20 weight percent to 40 weight percent.

29. The method of claim 24, wherein the sintered cemented carbide particles of the first mode are spherical, and the sintered cemented carbide particles of the second mode are non-spherical.

30. The method of claim 24, wherein the one or more additive manufacturing techniques is binder jetting.

31. A method of forming a sintered article comprising:
providing a powder composition comprising sintered cemented carbide particles having at least a bimodal particle size distribution, wherein sintered cemented carbide particles of a first mode exhibit a D50 particle size of 25 μm to 50 μm, and sintered cemented carbide particles of a second mode exhibit a D50 of less than 10 μm, and the sintered cemented carbide particles of the first and second modes have an average individual particle porosity of less than 5 vol. %;
forming the powder composition into a green article by one or more additive manufacturing techniques; and
sintering the green article to provide the sintered article.

32. The method of claim 31, wherein the sintered article is greater than 98% theoretical density.

33. The method of claim 31, wherein the sintered article has a porosity of A02B00C00.

34. The method of claim 31, wherein the green article has an average transverse rupture strength of at least 2 MPa.

35. The method of claim 31, wherein the sintered cemented carbide particles of the first mode are present in the powder composition in an amount of 60 weight percent to 80 weight percent, and the sintered cemented carbide particles of the second mode are present in the powder composition in an amount of 20 weight percent to 40 weight percent.

36. The method of claim 31, wherein the sintered cemented carbide particles of the first mode are spherical, and the sintered cemented carbide particles of the second mode are non-spherical.

37. The method of claim 31, wherein the one or more additive manufacturing techniques is binder jetting.
